(19) United States
(12) Patent Application Publication
(10) Pub. No.: US 2017/0153874 A1
(43) Pub. Date: Jun. 1, 2017

(54) METHOD OF RELATIONAL COPY-PASTE OF ENTITIES OF A MODELLED SYSTEM

(71) Applicant: INTERSYNTAX SAS, Boulogne-Billancourt (FR)

(72) Inventor: Raoul Barre de Saint Venant, Boulogne (FR)

(21) Appl. No.: 15/321,165

(22) PCT Filed: Jun. 23, 2015
(86) PCT No.: PCT/FR2015/000123

§ 371 Date: Dec. 21, 2016

(30) Foreign Application Priority Data
Jun. 24, 2014 (FR) 14 01414

(51) Int. Cl. G06F 9/44; G06F 9/54

(52) U.S. Cl. CPC G06F 8/20; G06F 8/34; G06F 8/35; G06F 9/543

(57) ABSTRACT

The present invention relates to a method of relational copying-pasting into a tool for controlling and commanding a development of a complex organism consisting of components which interact with one another, comprising an operator interface, a memory and a digital processing unit, the tool comprising in memory computer modelling software and a model of said modelling software containing entities, each modelling a component of the complex organism and exhibiting oriented links for describing its interactions with the other components, the method being characterized in that it comprises the implementation by the computer modelling software of steps of: (a) reception of a command for relational copying-pasting of a group of said entities, (b) independent relational copying-pasting of each of the entities of the group, so as to generate for each original entity a duplicate, (c) for each of said duplicates: o if the original entity exhibits an internal link incoming from another entity of the group, modification of the corresponding internal link from the duplicate of said other entity to the present duplicate. o if the original entity exhibits an external outgoing link, the abandonment of the corresponding link of the duplicate.

The field of the invention is that of modeling, monitoring and controlling of a complex organism.

An organism is complex in that it comprises a combination of components of the organism which interact with each other and with the outside, thus defining the behavior of this organism.

As shown in document EP1393209, in an organism each component itself can comprise a combination of sub-components, in turn considered as components and so on until they comprise elementary components whereof the behavior could be represented by autonomous elementary characteristics.

This representation of an organism can be analyzed as a combination of three types of relationships, each characterizing the nature of interactions between components.

The nesting relationship attests to monitoring by the nesting component of actions which can affect a nested component. This relationship for example considers the existence of walls then partitions for a building, or vials containing liposomes in cosmetics which fully or partly block sound waves and light waves. This relationship also conceives that duplication of a nesting component brings along that of all the components it nests by diffusion to all of its parts of the duplication action, behavior evident in the specific field but less evident when practically representations of the real field are manipulated in the form of computer objects.

The behavior of a complex organism with its environment is described by one or more functionalities defining how external stimulations can act on it.

Often, this functional relationship is analyzed by organization of the chaining of actions between components where each action on a component of an organism causes this same component to act in turn on other components, as noted for example in terms of clock mechanisms or business processes.

An example of such a chaining tree structure is that of complete recalculation of spreadsheet files (for example Microsoft Excel, registered trademarks) where calculation of each formula in a cell in return triggers that of cells taking it in reference in their formula and where some cells are put in relationships with several cells by means of a formula.

The dynamic management of a complex organism consists of acting on the construction of an organism. Document EP1393209 mentioned earlier uses the term management of development in this respect.

This consists more precisely of a relationship known as control between an initiating component and one or more patient components, allowing the first to act on the second by modifications to their own characteristics, their interactions with the other components or by partial or total duplication and more generally by any transformation. Optionally, the action is detailed in stages, each characterized by at least one period, the first stage starting at the beginning of the action and the last one ending on completion of the action; each of the stages which can further provide results and/or program sub-actions on sub-components, preset or determined as a function of the advancement of this action. Such action can describe the development of an enterprise by addition of new products or new means of production or development of a vegetable organism by meiosis of its cells for example. Cutting an action into stages can be independent of the description of the component in sub-components and, especially, it can be limited to providing monitoring points of its progression for tracking by one or more observers.

These relationships can be combined for the same component; a component can have one of its controls activated by the user of another component of sets of a chaining relationship. Similarly, duplication, nesting and chaining relationships can be combined as illustrated in FIGS. 8 bis and 8 ter. In these figures the symbol 1 represents a control action, symbol 2 represents a nesting relationship, symbol 3 a chaining relationship and symbol 4 a control relationship of relational copy-paste, the active elements being in black. They show a first component A nesting a component B and the chaining relationship between the control of the duplication of A and that of B. The duplication control of A is executed, then diffused to all its elements and, finally, the chaining relationship passes the duplication control to B and to its duplicate.

Hereinbelow the notation script will arbitrarily use the letter O without any prefix to designate the model of the organism O in its set, (x)O to indicate the organism seen as per “x”, “x” designating another entity, a relationship or a representation view. (x)O=A, B, C will indicate that O is represented as per 3 components respectively designated A, B and C. The script will then use the notation: (x)O=!A with “!” indicating that the component A is connected by an active element “x”, with “x” representing an interface for receiving the actions of users.

Nesting: The notation script will use the notation: O=A<B > or (A) O=B to indicate that the component B of the organism is nested by A, in other words that A monitors some of the relationships concerning the component B. (r) O=A<B> or (r) (A) O=B could even be specified to indicate that B is connected to A by the relationship r.

Control: The model O from the viewpoint of the control on A designated by * will be noted: (*) O=!A and when it concerns duplication the activation of * will give a new model O₁ and will be noted O→O₁. In the case of duplication without heritage of the control relationship, the result of the transformation will be noted: (*) O=!A→(*) O1=!A, A₂ and for duplication with heritage of the control relationship: (*) O=!A→(*) O1=!A₁, !A₂ or =!<A₁,A₂>, i.e., the duplicate in turn becomes independently duplicable by the same interface *. Following the description non-heritable duplications will be supposed, unless otherwise expressed.

Chaining: (x)O=!A,!B or =!<A,B> will mean that the components A and B react independently to the same cause, (x)O=!A !B or =!<AB> will mean that A reacts to x and B is chained to A for x and, i.e., B undergoes the operation * after A which transmits it. (x)O=<A,B,C> !D will indicate that the components A, B, C act by the same relationship on D, D aggregating the effects of actions in an overall effect, as in the example of a formula in a spreadsheet.

If the milestones of an action (*) on A are described by actions i, j, k which are chained, it is then noted: (*) O=A<!i !j !k> or (*) O=A ! <i j k>. In the case where (*) is a duplication transforming O into O′, there will be (*) O′=A !<i j k>, !A₂ <i j k>, i, j and k applying in the same way in A and in A₂ on similar sub-components. If (*) O=A !<($)B>, with ($) another control, there will be O1=A !<($)B, ($2)B2>, ($) and ($₂) being two independent controls.

As of now it is interesting to note the interest of such notation which for example simply describes a control acting on several components: (x) O=!<A,B> or else: (x) O=!A, !B for a direct simple action on each of the components and (x) O=!A !B for an action on A which then triggers an action on B. The combination of a control relationship with a nesting relationship is expressed in the system S: S=[(x) O=!A, (A) O=!B] if there is no chaining of the consequences of the action x on A towards B but also S=[(x) O=!A !B, (A) O=!B] when there is chaining, this latter notation combination having a particular interest for describing fractal or hypercube transformations as illustrated in FIGS. 8 bis and 8 ter. Note also that this notation designates the chaining of the relationships of given type in “process” according to the terminology of enterprises and finding their origin in the component A: (r) (A) O=! B ! <C, D> expressing that A is connected to B by a relationship of type “r” on B whereof the consequences are chained independently towards C and D and (r) O=! B ! <C, D> to designate this same chaining on the set of the model.

To monitor and control the development of a complex organism, models are often used which are run on computer systems creating and manipulating models composed of computer objects here called entities. The entities comprise measuring settings on the complex organism, variables which represent stimulations of the external environment and the model has calculation algorithms which correlate the values of these settings relative to each other and with the values of the variables as well as methods for creating or deleting entities. In this document, the interactions between a sub-set of such entities are modeled by relationships.

From the computer viewpoint:
a control relationship connects an initiating entity and one or more patient entities and organizes the action of the second by the first. It is described with the name of the initiating entity of the control (by default a human user and optionally another entity), the nature of the control and, optionally, the list of stages planning the progress of the control, each stage being characterized by at least one period of internal time to modeling, a descriptive of the part of the action which is associated therewith and often a value of given type. The partial action of a stage can provide for letting the user take charge of selecting its nature or else have been pre-programmed with a prospective logical precept.
a chaining relationship transmits action requests from a chaining entity to one or more chained entities. It relates to the chained entity and is described by the name of the entity likely to have it react, the circumstance of the triggering of the reaction and by the nature of the reaction. The succession of several chaining can be represented in the form of a tree structure when it is viewed in space-time, the propagation of controls taking a non-zero time. The root of this tree architecture then represents the control point of the chaining of all actions.
a nesting relationship connects a nesting entity and one or more nested entities. It is described by the name of the nesting entity, by the list of relationships which it monitors and by the designation of the nature of the monitoring for each relation. The nesting relationship is associative: a nested entity in another nested entity cumulates the monitoring relative to the relationships external to the final entity. The set of successive nesting forms a tree structure.

To summarize what concerns modeling, a relationship relating to an entity is described with the designation of the other entity and a list of various properties. Also, the same entity can be targeted by several relationships of several different natures in particular: nesting, chaining and controlling.

Often the modeling distinguishes relationships and links; the relationships within a group of entities are analyzed in combinations of one or more arrangements of entities two by two each of which forms an unambiguous link between the two entities. A link defines an action or a series of actions provided by instructions on one of the entities it connects, qualified as target entity, the other entity being qualified as source. Each entity is provided to interpret these instructions according to modalities particular to it and to manage their aggregation when it is the target of several links.

In this way, on a spreadsheet, the cell comprising a formula is the target of links using the information of cells which are referenced. In the case of a formula comprising several references in its title, the relationship is analyzed in the aggregation of several links targeting the cell containing the formula using the information contributed by the cells designated by its references.

After updating, the set of characteristics of the entities associated by these links is optionally balanced following a procedure determined by an algorithm acting on the entire model. So, on a spreadsheet, the set of values of the cells is recalculated after each refreshment by a procedure at the level of the spreadsheet file.

Such modeling then leads to qualifying the links according to several properties exploitable in computer terms:
Oriented and incoming or outgoing. A link impacting an entity is oriented and qualified as incoming for an entity if it is associated with the latter by declarative means and, in this case the link is qualified as outgoing for the other entity participating in the link where it will have no declarative indication. For example, in the case of a duplication relationship, the description of the control can be incoming for the entity to be duplicated and be associated with it, the other entity being limited to chain towards this control the initiative of its realization. Inversely the description of this duplication control can also be associated with the initiating entity of this control (for example an interface button) and the duplication becomes outgoing for the duplicable entity. For spreadsheets, the formulas define incoming links in the form of a permanent restriction interpreted by the cell bearing the formula and ultimately applied to its value. In biology the mitosis relationships are incoming for the cell, the relevant biological cell having instructions for execution of this division and the division being initiated by its environment.
Time limit. Execution of the action(s) described by a link can provide a time limit in the internal time of the modeling. So when this internal time limit is not zero, the circular references are easily interpretable within a range of internal time to the modeling.
Internal and external. A link affecting an entity of an identity set is internal relative to this set if it connects it to another entity of the set, if not it is external relative to this set.

In computer terms, it is possible to characterize the action of a duplication operation applying to a set of entities interconnected by relationships composed by oriented links modeling the interactions;
External regularity. Duplication is regular external for a set of entities if the duplicated entities retain the external incoming links (in other words these links are heritable) and lose the external outgoing links (in other words these links are not heritable). So for a spreadsheet, classic copy-paste is regular only when it is applied to cells fitted with absolute references (for example =$A$1) and linked to external cells by relative references (for example =A1). In contrast, for a project management program, copy-paste is not regular for relationships of precedence since when these relationships are external they are not duplicated irrespective of their orientation.
Internal regularity. Duplication is regular internal if the internal links are copied identically by this operation, i.e., described by the same properties except for designation of entities of the link which is replaced by that of the duplicate.
Regularity for a model. A duplication operation applying to a model made from a set of entities interconnected by one or more types of link of given nature is regular on this model if for this operation, for any type of link and for any sub-set of entities it is regular internal and external. Throughout this document such regular duplication is called relational copy-paste.

FIG. 8 shows a simple example of application of relational copy-paste. In this example legend 1 designates an outgoing relationship, legend 2 designates incoming relationships, legend 3 an internal relationship, legend 4 shows how the initial entity group is identified and legend 5 shows how the duplicated group is identified.

According to its configuration, the computer system develops a model for simulating, testing or regulating the complex organism, as shown again by document EP1393209. Often the model will use one or more representation views for displaying and modifying the properties of a selection of components, the whole according to a given formatting, for example tree structure or matricial, and displayed on one or more interface devices connected to the computer system.

To view chaining of the calculation relationships between settings of base entities or of sets of base entities concerning a component, the representation used could be that of a spreadsheet such as for example Microsoft Excel software™. If later the operating cycle of this component is to be viewed, the representation could be that of graphics software such as for example Microsoft Chart software™. For example, in an enterprise, the management specialist of a factory could want to see all data concerning a machine placed in the same column of a table and have each category of data such as productivity, time elapsed, etc. placed in the same line of this table; the representation software used could be a spreadsheet such as for example Microsoft Excel software (registered trademarks). This same specialist could later want to view in the form of a GANNT chart the progress of a decision implementation of a decision focused on boosting the production capacity of this factory by installation of a new machine; the representation software could be a project management program such as for example Microsoft MS-Project software™. Finally the specialist could want to edit and format a progress report on the decision implementation, the representation software could be a word-processing software which will offer various functions for organizing on a page the nesting of words in sentences, paragraphs, chapters and sections; this will be for example like Microsoft MS-Word™.

Many modeling software programs not only let the operator input and display input and output data but also let connect the entities via permanent restrictions to their properties or let provide modification of the latter at a moment of internal time to the modeling. Often the relationships managed by these software programs relates to a single mechanism, either controlling (such as for example mail managers), nesting (such as for example architecture software programs) or chaining (such as for example spreadsheets or project management programs). Often the software integrates a calculation module to balance the overall play of interactions by mathematical algorithms and end up with values called output data whether it be numbers for a spreadsheet, scheduling for GANNT tasks or layout for a text.

The complexity of an organism, due to the number and variety of its components and interactions, poses a problem for constructing, maintaining and using an effective model, i.e., which sufficiently reflects reality and which is exploitable advantageously, and for several raisons. This problem is that of performance of modeling work, analyzed here in two facets: efficacy and efficiency.

Some of these difficulties are linked to the efficacy of the modeling. They refer to:
organization of “who” acts to realize this monitoring-control. This difficulty is relative to the definition of responsibilities and dialogue modes around the development of a complex organism. This supposes giving to each of the managers an access to the relevant fields of their competencies to simulate the consequences of possible decisions. In terms of notation script this difficulty consists of expressing control relationships (*) and also the conditions of their meshing (chaining and nesting): (*)O,
definition of “on what” is done the action. This difficulty relates to the diversity of functional sub-models which can be used in the constitution of a model. These sub-models should be each easily informed by dedicated specialists who will bring their knowledge of the subject, then use it for simulations for their benefit or that of other specialists. In terms of notation script this difficulty consists of determining the range of types of relationships (r) between settings of components useful for definition of the model O and the lattice(r) O of their relationships in this same model,
definition of “how” is done the action. This difficulty relates to the representations which can be useful to the choice of actions of monitoring-control of a functional model. The tool must be able to facilitate coordination, discussion and amendment of the construction of a decision aimed at a new configuration of the organism by a supervisor or between several supervisors. In terms of script this difficulty consists of determining the modalities of a sequence of actions combining different controls (*), (*′), (*″), illustrating a development “scenario”,
definition of “why” is done the action. This question relates to the advantage there would be to evaluate its consequences prior to making a decision, by producing several variants of the same model or relates to the high volatility of the constitution of some complex organisms [as shown in document EP1393209] making the results of an action random. The issue is to select the evolution scenario of the model maximizing the performance objectives of several people given the possibilities which would be presented later in terms of opportunities to seize and risks to avoid. The tool must create, manage and compare several scenarios of the considered decision. In terms of notation script this difficulty consists of associating a provisional result with different forecasting scenarios: S₁, S₂, S₃, S₄ . . .

Added to these difficulties are those linked to the efficiency of the modeling: organizing the construction and maintenance work of the model such that this work is fast and reliable with an easy access to the results.

In terms of notation script this difficulty consists of facilitating the layout of entities and their relationships as well as those of controls for models construction by duplication, and of making the result of these constructions easily accessible to other users. It can be about display controls when there are available, tools for pre-programming sequence of relational copy-paste and a collection of representation interfaces combining partial displays of the model, displays of controls and/or of access to a notation script edition interface for controlling the duplications in a model by a user.

Note that commercially available generic modeling software programs offer only a few of the services necessary for such complexity. They respond only partially to the problem presented hereinabove, since they are often centered on implementation of a single type of relationship, relating either to nesting, or to chaining or to controls, since often they are arranged for presentation in a single format for data, with a few minor variants, and since they are often poorly arranged for providing services for the construction of representations of components. For instance, Excel, as most software programs for managing industrial processes, is centered on chaining type relationships between cells and groups of cells, MSProject on monitoring decisions described by tasks relating to one or more components, Powerpoint on distance and inclusion type relationships between geometrical shapes and texts and finally database management system programs on property data of entities.

In their range of construction services of models, these software programs, for accelerating the work of its users, often propose “vernacular” copy-paste functions; these services copying part of a representation to another place in the model (copy-paste) or resulting in the single displacement of the source (cut-paste). The radical “-paste” of these two functions refers to various processing of the relationships between relevant entities, according to implementations. For example, the spreadsheets rely on the presence of symbols ($ meaning an absolute reference) placed on the references of formulas, slide-show presenters ignore the relationships external to the set of duplicated entities, project management programs fix the external relationships of the copy as a function of the place where they are pasted and text editors (word processing and computer code emulator) have complex behaviors both linked to the morphological content and to the semantic content. Also, these conventions on replication of relationships fail to reduce complementary adaptation work which can be important and a source of errors, especially for modeling using spreadsheets.

There is no universal description of this copy-paste operation applying in the same way to relationships irrespective of their nature and which is adapted to the construction of models. Also, still concerning spreadsheets, the vernacular operation of cutting and pasting is not regular, since only absolute references (for example: =$A$1) of formulas of a cell are regular external and only relative references (for example =A1) of formulas of a cell are regular internal.

In sum, there is no generic control-command tool of complex organisms managing the three types of relationship mentioned above and integrating around a central database services facilitating complex developments.

Such a situation jeopardizes all initiatives to develop a general construction method of models benefiting from collective organization of work and compliant with varied types of relationship.

### Presentation of the Invention

To bring a solution to the problem posed, the aim of the invention is a tool for modeling, monitoring and controlling development of a complex organism comprising components which interact with each other.

The tool comprises several items of human interface equipment (computer screens, keypads, mouse, cameras, etc.), memory, a digital processing unit and one or more connections to digital networks. The tool is characterized in that it comprises in memory:
a computer class whereof the instances, called entities, are organized into a collection, in the computer sense of the term, called model, which interact by relationships composed of links oriented any way and which are provided to each model a component of the complex organism as well as to represent its states and its interactions with other components,
a tool for controlling an action of relational copy-paste of any selection of entities of the model and for balancing the relationships of the model resulting from this action.
a representation application, instance of a computer class, for:
   displaying on one of the representation interface equipment a view containing a selection of the collection of entities and some of the properties of the latter.
   giving access and validating exploitation of the properties, relationships and controls of relational copy-paste as well as controls of inverse deletion operations relating to the entities of the selection displayed or some of the sub-sets of the model.

This tool lets each specialist accessing a representation interface access any entity of the model and modify the properties based on his knowledge of the sub-component of the organism to which this entity corresponds. Then the specialist can create another separate entity but one having the same characteristics as those he knows. The specialist does not need to worry about formatting information on the components which fall within his field of competence since the representation interface automatically accesses information relative to the preferred entities and formats it according to the required layout.

In terms of notation script, this tool constructs models by duplicating a list of any entity before balancing its relationships:

O=A→O′=A₁ A₂

It could also examine the model according to a particular relationship r:

O=A→(r) O=A

In particular, those coming from a particular entity E

(r) (E) O=A

A user, a technical specialist for example, accessing a model could modify the representation by actions of relational copy-paste or inverse deletion of entities without having to think about the relationships between each of the entities, each of its actions corresponding to what it controls on the part of the organism for which he has responsibility. Access to this model will let him view a situation underway whether for interpreting the information available on the current situation, for simulating the effect of a sequence of possible decisions or finally for tracking the implementation of decisions which he has engaged.

It can be that the technical specialist is dissatisfied with the first modeling tool which in general has him repetitively specifying the detail of entities at each duplication he wants to make.

Advantageously the software is arranged for programming relationships between entities comprising at least one relationship of each of the following types:
nesting by an entity of one or more other entities,
pre-programmed relational copy-paste control applying in an incoming way to a selection of entities and to those which each nests,
chaining of several pre-programmed relational copy-paste instances following the control of initial pre-programmed relational copy-paste.

In terms of notation script this tool enables to construct models by grouping entities into an entity of superior nesting order and to program relational copy-paste on the latter, then chaining such copy-paste in sequences. In terms of notation script there is, for example:

Nesting:

[O=A and (A) O=<B, C, D>]

Relational copy-paste, this relationship being incoming (heritable):

(*) O=!A→(*) O′=!A !A₂→(*) O′=!A !A₂ !A₃ !A₄

Chaining, this relationship being incoming (heritable):

(*) O=!A !B (*) O′=!A !A₂ !B !B₂:

Nesting combination and relational copy-paste:

[(*)O=!A and ($)(A) O=<!B>]→

[(*)O′=!A !A₂ and ($)(A)O′=<!B> and ($₂)(A₂)O′=<!B₂>]→

[(*)O″=!A !A₂ and (!)(A)O″=<!B> and ($₂)(A₂)O″=<!B₂!B₂₂>],

Combination: relational copy-paste (incoming), chaining, nesting:

(*) O=!A<!C> (*)O′=!A <!C !C₁₂> !A₂<!C₂₁!C₂₂>

A user, for example a technical director, accessing a model after its updating by several of its technical specialists, could access a representation interface enabling him to modify the model by a sequence of relational copy-paste or of inverse deletions which will have been pre-programmed, for example by a specialist in model design, in tasks centered on simulating an evolution of the organism towards a new situation.

It can be that a user is dissatisfied with the second modeling tool which, by giving all the duplicates the capacities of heritage of the relationship of relational copy-paste, multiplies the number of entities produced at each duplication while he would as well be able to control additional effect from duplications.

Advantageously the software is arranged for each relational copy-paste control to be interpreted as an outgoing relationship relative to the selected entities and to those which each are directly or indirectly nested and, this, while other control relationships of the model could remain incoming for this same control.

As a consequence, as per the rules of relational copy-paste, a control relationship will not be duplicated by its own action since it is an external outgoing, but by contrast this duplication will apply to other internal control relationships affecting duplicated entities (this principle is illustrated by FIGS. 8 bis and 8 ter) whether these control relationships are chained or not.

In terms of notation script this tool constructs models by the optionally chained and pre-programmed diverse relational copy-paste. For example:
with a duplication with outgoing characteristic where only the pivots (duplicable entities of the initial model) remain duplicable:

(*)O=!A→(*) O′=!A, A₂→(*) O ″=!A, A₂, A₃
or else, to illustrate simple chaining:

(*) O=!A !B→(*)O′=!A !B, A₂, B₂→(*) O″=!A !B, A₂, B₂, A₃, B₃
or else by accounting for the balancing of chaining relationships contained by the duplicate of the pivots after each duplication.

(*) O=!B<!C> then: (in this respect see FIGS. 8 bis and 8 ter)

(*) O=!B <!C> (*)O′=!B <!C, C₁₂>, B₂<!C₂₁, C₂₂>→(*)O″=!B <!C,C₁₂,C₁₃>, B₂<!C₂₁, C₂₂,C₂₃>, B₃<!C₃₁, C₃₂, C₃₃>

The invention lets a modeling specialist construct a model by starting with construction of a model characterized as minimal, consisting of:
creating entities each associated with the group of components of the organism similar in characteristics and internal interactions and having the same external interactions with the same components,
completing the modeling by connecting these entities via the controlling, chaining and nesting internal and external relationships according to their interactions,
then, structuring them by duplication relationships optionally chained so as to be able to render a model known as base faithfully representing the entire organism after appropriate application of these controls by a user.

Once the minimal model is constituted, the same specialist could move on to proper construction of the base model by duplicating some of them using controls pre-programmed at the preceding stage and meanwhile appeared on the interface to account for their availability. He will then provide access to this model enabling its users to make it evolve quickly, easily and without error and, benefiting of a representation of higher level, being no longer concerned with the detail of relationships to be set up between constitutive entities.

It can be that a user is dissatisfied with the third modeling tool due to insufficient variety of representations of the field covered to which it gives access, preventing him from configuring the representation to a restricted or bigger selection of the elements he wants to consider simultaneously according to his attributions and intellectual approach.

Advantageously the computer modeling software is arranged to display alternative representation views of the same model, each by means of two pre-recorded files, the first containing a database request of SQL type for extracting data to be displayed and the second describing a procedure of CSS type for arranging the extracted data on a presentation screen;

In terms of notation script if the “view” S contains the object A, this gives: [O=A, B, C and (S) O=A]

A user, for example a technical director, accessing a model after its updating by several of his technical specialists could have therefore access to several representation views whereof the knowledge, then easier, will let him modify the model by actuating a sequence made of duplications and/or deletions of entities prepared by a designer, some of these actions being developed to simulate evolution of the organism towards a situation better representing the current situation.

Next, the members of a user group, for example an executive committee, accessing a model after its updating, could create a copy of the model and gradually modify the representations to which they will have access by duplications or deletions of entities, thanks to pre-programmed tasks, or by direct modifications of their properties. These actions will be thought out to simulate an evolution of the organism, called “scenario”, towards a preferred situation. This process, being accountant for the restrictions particular to each of the users, will reduce occasions of conflicts for availability of represented components and for resources availability and, therefore, will more easily end up with a consensual situation.

Similarly, the group of users mentioned hereinabove or an individual user, for example the finance director, could simulate several alternative scenarios to find a scenario more satisfactory or to evaluate the solidity of a scenario relative to variations in the environment as illustrated by the model.

It can be that a user or a group of users is dissatisfied with the fourth modeling tool, arguing that the effort of moving from one representation view to the other then to visually searching the entity to be selected and finally produce one of the desired duplications is inappropriate for those already having already a knowledge of the model through its different views, identifiers of the entities, controls and their chaining and/or nesting.

Advantageously the tool has a text interface, displayed on a screen, a voice interface with a micro or gesture interface with a camera, each being used to command with the mean of the script the display of the existing entities and the possible controls in a scenario of the model, the execution of these controls and the display of a scenario as per a combination of pre-programmed views and, optionally, the refining of this display by redaction of a more detailed complementary request according to another standard.

With a model being open a user could save time by more easily passing his instructions for construction and visualize in symbolic form the consequences of this construction before and after processing by computer. Also, of several users knowing the same model, the one who will modify it could settle for simply communicating to his associates the script used for modifying it and have the exact composition of the new version understood with minimal effort for his interlocutors.

### PRESENTATION OF THE FIGURES

Many details and advantages of the invention will emerge from the following description of the embodiment and which is presented in reference to the appended drawings in which:

FIG. 1 shows a tool according to the invention;

FIG. 2 shows an architecture tool according to the invention;

FIG. 3 shows a structure of software objects activated and administered by modeling software according to the invention;

FIG. 4 shows a flowchart linked to the setting of an entity;

FIG. 5 shows a flowchart linked to entity duplication;

FIG. 6 shows a flowchart linked to a procedure of relational copy-paste;

FIG. 7 shows a flowchart linked to an entity deletion;

FIGS. 8, 8 bis and 8 ter illustrate examples of use of relational copy-paste, simple then combined.

### DESCRIPTION OF A DETAILED EMBODIMENT

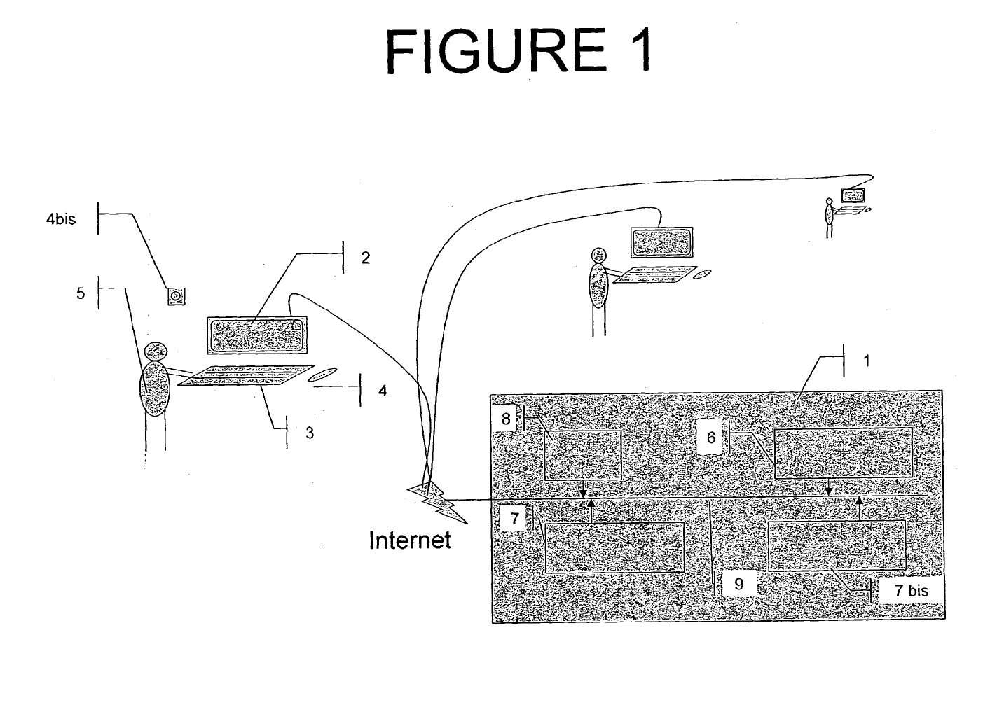

In reference to FIG. 1, a tool to let a user 5 monitoring and controlling development of a complex organism is produced by means of a computer 1 with an operator interface comprising a screen 2, a keyboard 3 and a mouse 4. The computer 1 comprises a digital processing unit 6 and a memory 7 which the digital processing unit 6 accesses via a bus 9. The various elements of the operator interface are connected to an input/output device 8 which the digital processing unit 6 accesses via the bus 9.

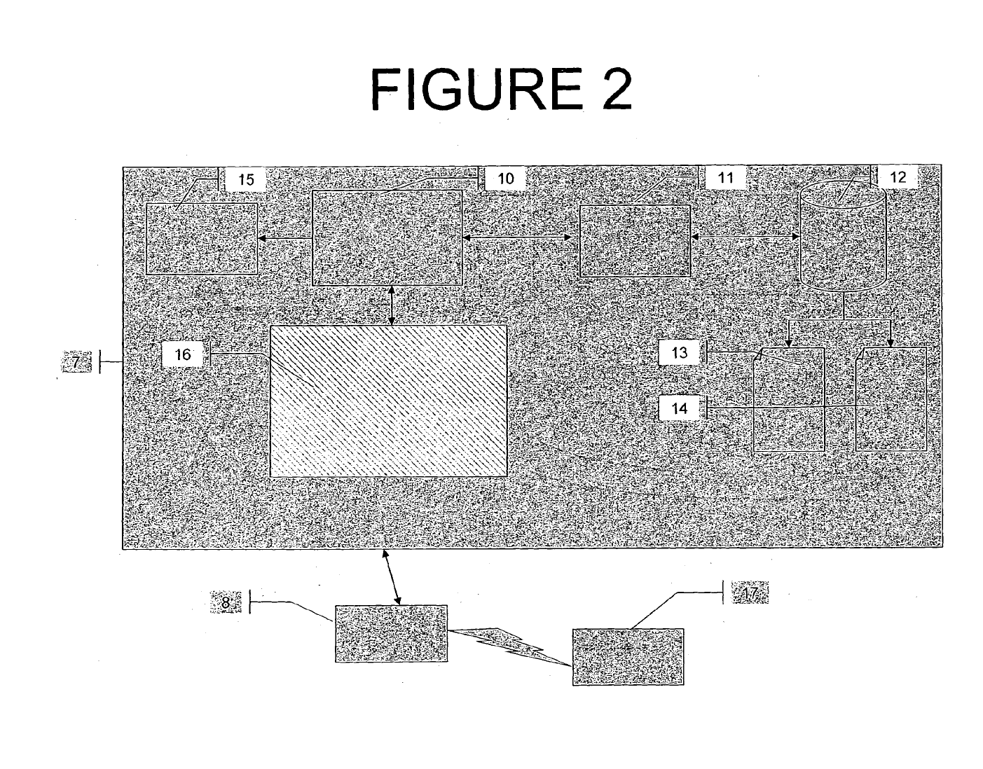

In reference to FIG. 2, the memory 7 of the computer 1 comprises several software bricks 10 to 18. Each software brick comprises a set of programs and/or data. The programs are contained in files that can be run by the digital processing unit 6. The data are contained in data files accessed by the programs when the programs are run by the digital processing unit 6.

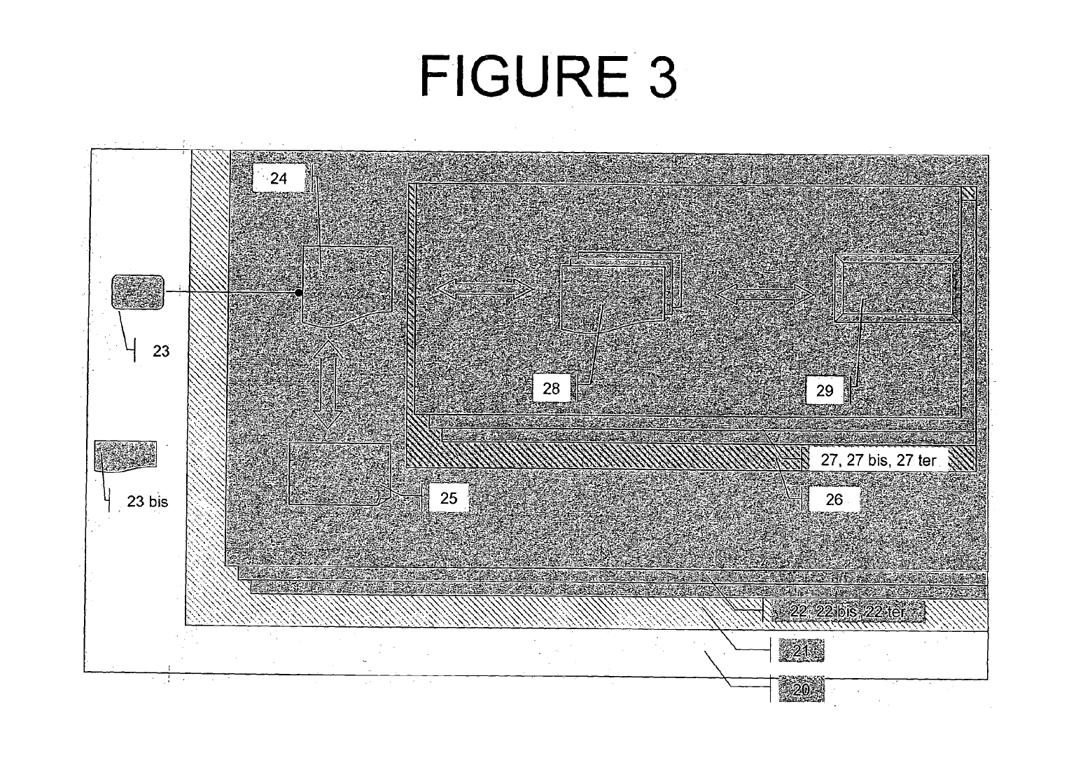

Reference 16 designates representation software provided for communicating with the input/output device 8 to display data on the screen 2, input data from the keyboard 3 or the mouse 4 via the browser 17. It is configured to access the data of the model in memory of the modeling software 10 by a request to read with the DBMS 11 the data of the file 12 archived in the storage support 7 bis, extract from there a selection then display the data and the interfaces of this selection as per a view 27, 27 bis or 27 ter, etc. (presented in detail later via FIG. 3) on the interface equipment of the user 2 as per a procedure provided in advance and defined for example in a CSS3 file of the HTML5 standard. The representation application executed by the digital processing unit 6 not only dialogues with the browser 17 to display and input data or controls of the operator interface, but also has calculations made on these data by the software 15.

The representation application, due to the functionalities for input, calculation and presentation to which it gives access, is particularly adapted to perform one or more views 27, 27 bis, etc. which illustrate a partial representation of the complex organism, each in a modeling world which is particular to it: that of functionalities (for example: economic and financial flows) when it is about chaining relationships between cells of spreadsheet type, that of strategy for when it is about the display of control relationships, that of managing decisions on development of a complex organism (for example: management of the implementation of a strategy by the project management program) when it is about nesting relationships especially by the hierarchical display of transformation controls of a model.

The memory 7 can contain other representation applications for modeling the complex organism in other world of specialized functionalities such as for example the world of combustion, the world of electricity and the world of mechanics for modeling an engine. The data attached to one or the other of these representations will be activated by means of a formatting file adapted to this software and to these worlds.

The software brick 10 consists of computer modeling software according to the invention. It is configured to interact with the browser 17 which is constructed to intercept inputs made on the interface tools 3 and 4 by the user 5. In the software brick 10 are programmed functions for transforming the list of entities of the model, especially duplicating, modifying and deleting some of them with each other and organizing balancing of relationships between entities by using calculation software 15.

In reference to FIG. 3, the modeling software 10 uses object-oriented architecture in which each object structure it manages is an instance of class in the computer sense of the term from which the data will be provided by the database stored on the archiving support 7 bis. The modeling software 10 enables management in memory of a “model” object 20 containing as property a collection of entities 21 called “scenario” (each realizing an instance determining representation of a type of complex organism, for example the development of a given enterprise), an entity class for instancing all the entity objects used by each scenario object and a “views” collection 26 which will contain instructions necessary for formation of view objects 27, 27 bis, 27 ter, . . . (presented in detail later via FIG. 3). The object 20 constitutes a root object for performing operations on a collection 21 of scenarios.

The object 20 also has various properties not indicated in FIG. 3, and it is about a character string called “Db_path” indicating the location of the data file 12 in the storage space 7 bis, a character string called “Db_name”, a character string called “Name”, a work space class called “Wrkjet” containing the instance of the DBMS 11 for accessing data and an entity class 23 containing as property a creation date, a unique “identifier entity” for uniquely identifying each of its instances, a “creative identifier” (for identifying entities constructed by some users, especially the model designers, and distinguishing them from those coming from duplications made by other users) an entity name, and the properties necessary for describing the relationships of its instances with other instances.

The database “Db” indicates the database software DBMS 11, provided to ensure persistence of the data structures managed by the modeling software 10. The character string “Db_name” indicates the name of the file which contains a data structure. The character string “Db_path” indicates the path for accessing the data file indicated by the character string “Db_name”.

The “Scenarios” collection 22 is a collection of objects (22, 22 bis, 22 ter . . . ) of “scenario” type explained below.

The character string “Name” indicates the name of the object 20 to distinguish it from any other instances of the “Model” class which would be in memory. The work space “Wrkjet” indicates, as needed, the execution environment of the database management program 1 for the object 20.

An object of scenario type such as for example the object 22, as indicated in FIG. 3, comprises a collection of objects 24 of objects of “entity” type, containing properties for describing them and their relationships and all instances of the class 23, a collection 26 of objects representation views (27, 27 bis, 27 ter . . . ) and the collection 25 of request files for formatting the views.

For methods, the object 20 has the procedures for reading in the database the data corresponding to the scenario 22 associated with a property “Name”, for saving all data and for clearing the memory of the computer of these data when the application is closed.

The collection 24 contains the entities constituting a scenario. The collection 26 of views contains objects of view type, all instances of a view class of the representation software 16. Each view (27, 27 bis, 27 ter) is indexed by a separate name and contains properties extracted from the collection of request files 25 especially an extraction file (for example of SQL format) for extracting from the collection 24 a selection of objects and some of their properties as well as a formatting file (for example CSS3 of HTML5) for generating the image file 29 displayed on the presentation equipment.

Each object of “entity” type of the collection 24 represents in the computer model a component of the complex organism. In the case where the object 20 is provided for modeling an enterprise, an entity of the collection 24 can represent a holding, one or more other entities of the collection 24 can each represent a company of the holding, one or more other entities of the collection 24 can each represent a site of a company.

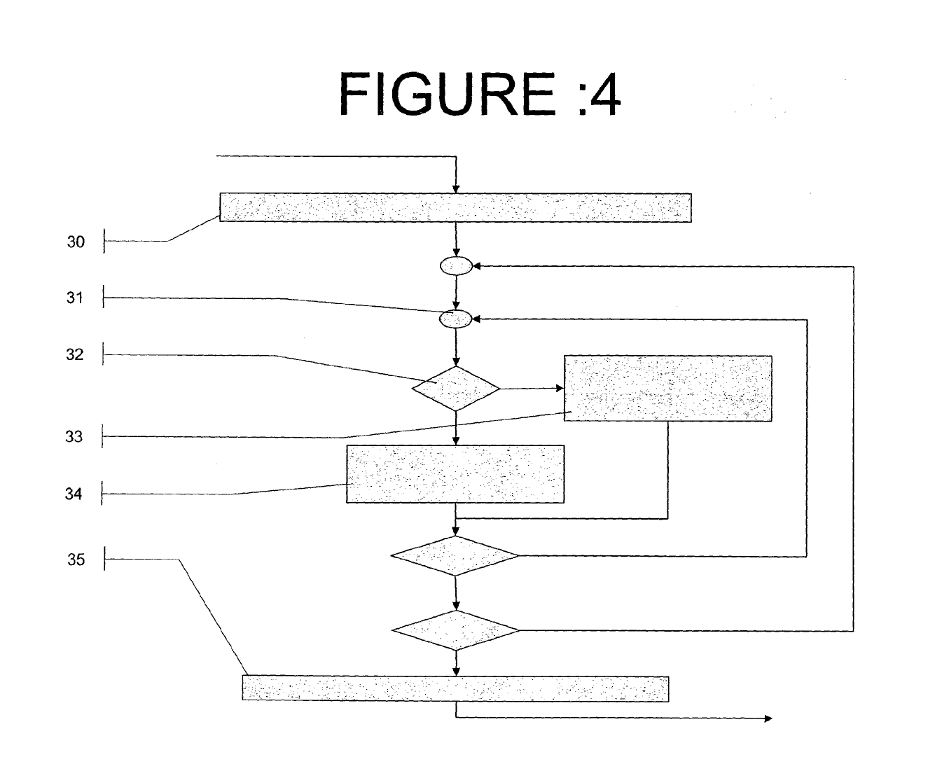

The object structure managed by the modeling software 10 is exploited by the modeling software by way of programs resident in the memory 7, flowcharts of which are given in FIGS. 4, 5 and 6.

In reference to FIG. 4, the modeling software 10 activates the sequence of stages 30 to 35 when it detects a request of relational copy-paste extracted from the entity collection 24. Where appropriate, the software also moves the “chaining group” containing all the entities to be duplicated following the control having launched this relational copy-paste procedure.

In stage 30, the software duplicates all the entities of the group to be duplicated by identically preserving in the new entity all their properties except for the “entity identifier” which will receive a new value letting it be indexed uniquely.

In stage 31, for each new entity, it launches the correction procedure of incoming internal links described in the relational settings (control, chaining, nesting). For this, each relational setting of the entity which has been duplicated is conserved except for the designation of the target of new links revised in the following stages 32 to 34:
If in stage 32, the software detects that the corresponding link in the entity of origin is internal to the group to be duplicated, stage 33 is started.
In stage 33, the source of the new link becomes the copy of the entity which was the source of the former entity.
If the condition of stage 32 is not fulfilled, stage 34 is started. This stage processes three cases:
   if the source entity of the link is an entity listed in the chaining group and if it has already been duplicated, the duplicate of the entity now identified is taken as source of the new link,
   if the source entity of the link to be processed has not been duplicated it is placed in a “buffer” collection waiting to set up its new relationship,
   if the source entity of the link does not belong to the chaining group, the relational setting of the entity is retained identically.

When all the entities of the group to be duplicated have been processed, in stage 35 the “buffer” collection is then explored to identify, if needed, the entities of the collection 24 awaiting correction. On completion of this stage 35, the collection 24 is updated with new entities and old ones which have been modified and the procedure is reconnected on the appeal procedure.

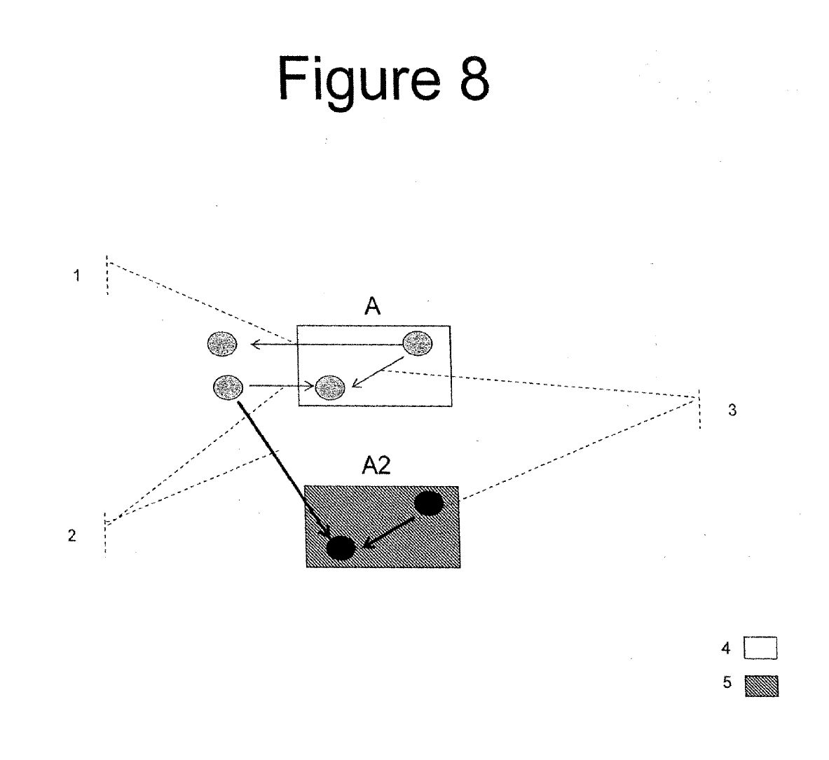

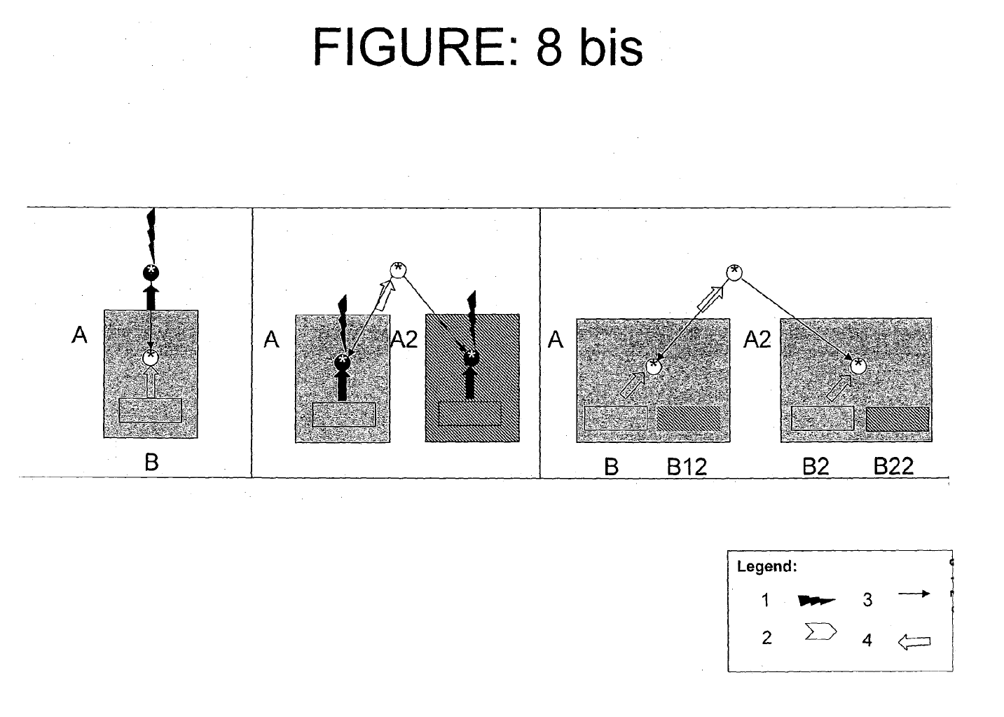

A particular application of this method is illustrated in FIGS. 8 bis and 8 ter.

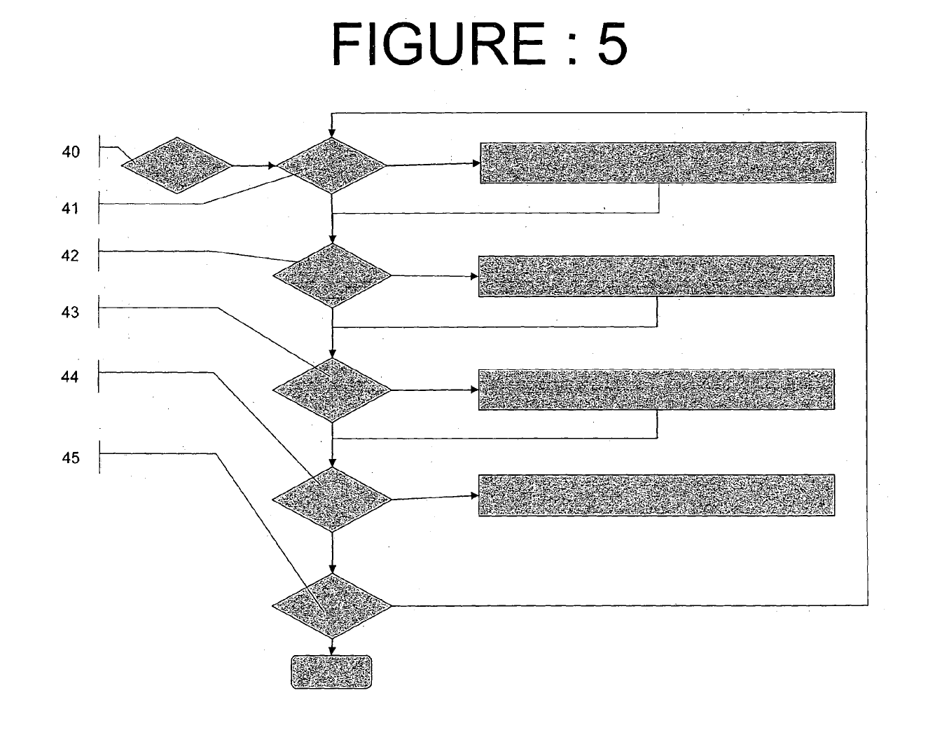

In reference to FIG. 5, when in a stage 40 the modeling software 10 detects selection of an entity on a representation interface of the collection 16, it activates a sequence of stages 41 to 45.

In stage 40, it proposes on the representation interface the addition of a new entity following stage 41 and/or continuing setting of the entity or its modifications as per stages 42 to 45.

If the user chooses to create a new entity, the representation application intercepts the event and requests the modeling software to create a new entity having settings in keeping with the default values as agreed for the properties of the description of the class of entities 23. This default setting comprising at least the attribution of an “identifier entity” setting and a “creative identifier” setting, one and the other composed of the same character string for detecting the entity uniquely among the set of entities of the object 24, comprising attribution of the name of the user to the “control. source” property, comprising attribution of the date of the moment of creation to the property “creation date”, comprising attribution of the identifier of the entity located above its point of insertion on the representation interface to the “nesting.source” property and leaving the other chaining properties a default value defined by base setting of the modeling software 10.

In stage 42, the user is called to indicate which control could be activated from this entity. For this purpose the control setting fields will indicate at least one entity name of initiating control and associate with each a set of one to several stages, each optionally containing a field for entering a period of internal time to modeling, a value field containing a character string and an instruction field for describing the relationships of this stage with a stage of the same entity or another entity. When the list of stages is to contain just one element, the period field will have the “permanent” value signifying that the other indications of the stage do not depend on the time of the modeling. For example, for an application of spreadsheet type, the control fields will comprise a single permanent stage only, i.e., whereof the period field will have in keeping with the agreement cited above the “permanent” value and which also will be such that its value field will be set by a digital or text character string and such that the instruction field will contain a reserved conventional indication, for example the “functional” value, meaning that this entity is called to program a restriction on the value of another entity. A variant of this example is the case where some entities have in addition to the first control with a single stage, described hereinabove, a second control also provided with a single stage, consequent permanent also, and whereof the instruction will make reference to an instruction of relational copy-paste of the modeling software 10 and which will use the value of the value field of the stage to indicate the number of times when duplication will be applied with this same control. Another example would be application of project management program type, where each entity would have any number of stages, each attached to any period of the internal modeling time and each with the field of instruction containing instructions interpreted by the modeling software 10 for relationships of precedence with the other stages.

In stage 43, the user is called to indicate which nesting link the entity will accept from another entity. To this end the setting will have a field to indicate the nesting entity and will have a list of properties each of which will propose at least one field for describing the relationships which will be monitored by the nesting entity as well as a field to indicate the nature of the monitoring. For example, in terms of property relationships, this consists of prohibiting its access to users other than the owner of the nesting component; in the case of an enterprise, information on production of a factory could be intended only for accounts department; in terms of investment, investing decisions in a new machine identical to the preceding will be made only by the director of the factory and the financial director.

In stage 44, the user is called to indicate one or more chaining of the entity, i.e., to inform for each with each other a property having at least one field to indicate the reactive entity, at least one field to advise the circumstances of the reaction and at least one field to specify the nature of the reaction. For example, it will associate the stage of another entity, called chaining with one of its stages, called chained, such that the first, once completed, activates the instruction of the second. Note in this respect that the chaining entity can also designate a user of the tool. For example, in an application of spreadsheet type, as shown above, the value of the single stage of the control of a chaining entity can be used as a setting of a calculation described in the nature field of the reaction of the single stage of the control of the chained entity; it appears in the form of a reference (for example “A1”) in the associated formula (for example “=A1+B2”. In these conditions, as per all applications of spreadsheet type, the formula relates to a procedure of the modeling software 10 arranged to use as variable the value(s) of controls of the chaining entities and place the result of the formula in the value of the control stage of the chained entity. Alternatively, still in the case of application of spreadsheet type, chaining can designate a user of the tool and have an instruction as to why the character string input by the user is registered as value of the same control field of the chained entity. So in the first of these two cases the setting of single chaining between entity could give for example “=A1” or “=exp(2*A1+7)” in the formula or, when the chaining is multiple, “=sum(A1:B1)” and when the target entity will be a user it will similarly display the entry of the latter for example “Our ancestors the Gauls”. As another example this chaining can be about two duplications, such that taking the final stage of the first duplication causes the start of the first stage of the second duplication.

In stage 45, with setting of the entity underway finally completed, the user proposes choosing between setting of the following entity or stopping the setting sequence.

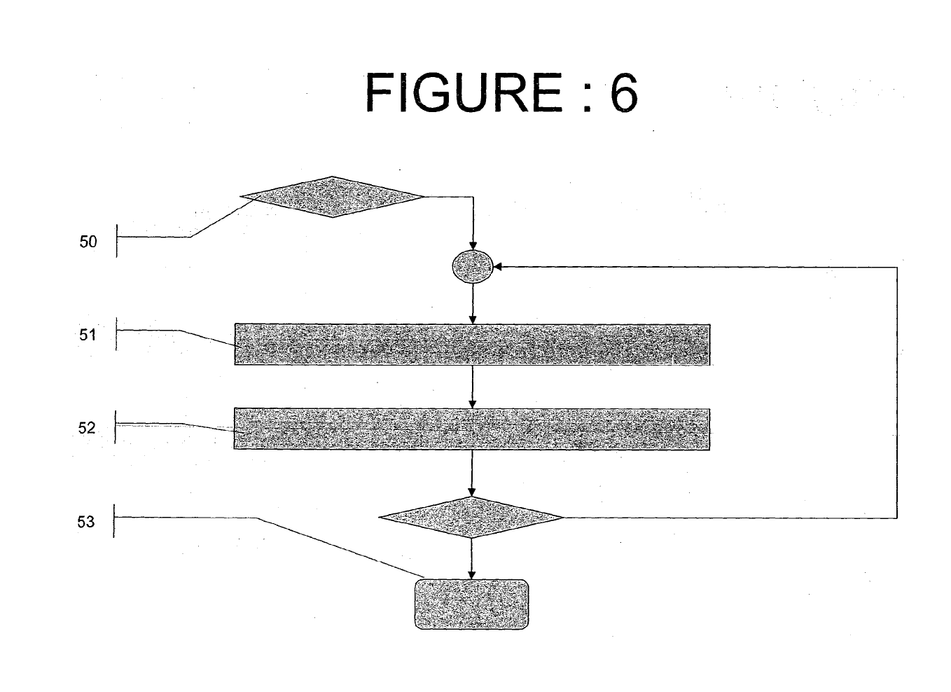

In reference to FIG. 6, when in a stage 50 the modeling software 10 detects a valid duplication request on an entity of the object as active representation of the collection 16 it activates the sequence of stages 51 to 53.

In stage 51, the software places in a computer collection known as pivot the identifiers of all the entities concerned by duplication. The latter are those directly or indirectly in nesting relationship with the entity selected for duplication called “origin entity”, the quality of indirect nesting deduced from one or more transitive relationships of nesting and/or chaining for this same duplication action. For example an entity is indirectly nested when it admits as nesting entity another entity which in turn accepts the selected entity as nesting relationship and, as other example, an entity is indirectly nested when it accepts as nesting an entity which accepts chaining with duplication with another entity. Also, this selection will retain pivot entities only, i.e., will keep only the oldest according to the property of “creation date” among those having the same “creative identifier”. This latter disposition again prevents duplication of entities which have just been duplicated when the duplication relationship is interpreted as outgoing. Finally and in last place, the collection is reorganized as a function of the tree structure of the entities receiving the duplication actions chained with the duplication of the “origin entity”. For each of the entities chained for the duplication with the “origin entity” this reorganization consists of creating an entity group comprising this entity and all the entities it nests, then placing this group in a new collection called tree structure where the groups will be sorted in the order cited above, that of the tree structure of the chaining of the entities for the duplication of the “origin entity”, this order being calculated starting from the root.

In stage 52, the software uses the order of the groups of this tree structure collection to move the groups of entities to the “relational copy-paste” procedure as well as the number identifying the group to be duplicated in this collection and at the same time as a reference to the tree structure collection to be duplicated. This relational copy-paste procedure is described in FIG. 4 detailed hereinabove.

In stage 53, as long as the whole tree structure collection has not been duplicated, the software increments by a unit the identifier number of the group having become a variable at stage 52. It starts the balancing of relationships and especially that of duplication and, if a new request for duplication appears, it restarts stage 52, and if not it stops the procedure.

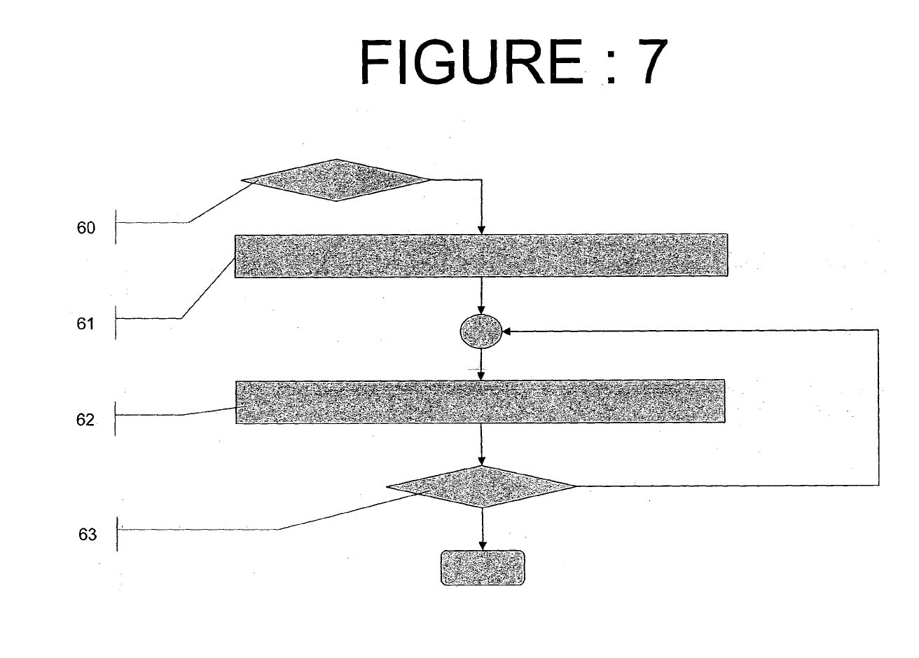

In reference to FIG. 7, in a stage 60 when the modeling software 10 detects a valid deletion request on an “origin entity” of the active representation view (27, 27 bis or 27 ter, etc.) of the collection 16 it activates the sequence of stages 61 to 63.

In stage 61, the software places in a computer collection, called a pivot, the identifiers of all the entities which will be concerned by deletion. The latter are those directly or indirectly in nesting relationship with the selected entity, the quality of indirect nesting deduced from one or more transitive nesting relationships and/or chaining for this same duplication action. Also, this selection will keep only entities of the same rank, i.e., it will retain only those having the same rank among those in the list having the same “creative identifier” as the entity which has been selected to signify duplication.

Finally, in the same stage, the collection is reorganized as a function of the tree structure of entities chaining the duplication action with the “origin entity” bearing the deletion, this reorganization consisting of creating for each of the chained entities for duplication an entity group comprising this entity and all the entities it nests by placing this set in a new collection known as tree structure made of these sets of entities and organized in the order of the tree structure of the chained entities for duplication action by the “origin entity”, this order being calculated by starting from the root.

In stage 62, the modeling software 10, in the order of this collection, in the collection 24 of the model deletes the entities corresponding to the entities of each group.

If in stage 63, the software detects another deletion, it restarts stage 62 for new deletions, and if not it stops the procedure.

### Practical Execution

A computer program product comprising code instructions for executing a method according to the invention in a tool for monitoring and controlling a complex organism development comprising components which interact with each other.

A storage means readable by a computer device on which a computer program product comprises code instructions for executing a method according to the invention in a tool for monitoring and controlling a complex organism development comprising components which interact with each other.

1. A method of relational copy-paste into a tool for monitoring and controlling development of a complex organism comprising components which interact with each other, comprising an operator interface, a memory and a digital processing unit, the tool comprising in memory:
a computer modeling software and
a model of said modeling software containing entities, each modeling a component of the complex organism and having oriented links for describing its interactions with the other components, the method of relational copy-paste being performed by the computer modeling software and being characterized in that it comprises at least the stages of:
(a) reception of a relational copy-paste control of a group of said entities,
(b) independent duplication of each of the entities of the group so as to generate for each original entity a duplicate,
(c) for each of said duplicates:
if the original entity has an internal link incoming from another entity of the group, modification of the corresponding link from the duplicate so as to establish it between the duplicate of said other entity and the present duplicate,
if the original entity has an external outgoing link, abandonment of the corresponding link of the duplicate.

2. The method according to one of the preceding claims, the tool comprising in memory a representation software, the method further comprising a stage (d) for displaying on said operator interface by said representation software a view for providing access to some properties of any selection of the entities, including the generated duplicate.

3. The method according to one of the preceding claims, further comprising a stage (e) of substitution by other entities of the model defined in advance with entities located outside of said copied-pasted group and involved by an incoming link and external to the same copied-pasted group.

4. The method according to one of the preceding claims, wherein a plurality of copy-paste operations concerning several disjoint entity groups respectively is chained, stages (a) and (b) comprising successive execution of said operations and stage (c) being performed with respect to the assembly formed by combining of the groups.

5. The method according to one of the preceding claims, wherein an entity can comprise several nested entities of lower order, stage (b) comprising for such an entity execution of the method in chained manner and stage (c) being performed with respect to all the entities and considering the nesting relationship as consisting of links between nesting entities and nested entities.

6. The method according to claim 5, wherein control of the relational copy-paste operation on an entity group is interpreted as composed of outgoing links relative to the entities of said group and to those which each nests directly or indirectly.

7. A tool for monitoring and controlling a complex organism development comprising components which interact with each other, including an operator interface, a memory and a digital processing unit, the tool being characterized in that it comprises in memory
a computer modeling software and
a model of said modeling software containing entities, each modeling a component of the complex organism and having oriented links for describing its interactions with the other components, the computer modeling software being arranged for performing:
(a) reception of a relational copy-paste control of a group of said entities,
(b) independent duplication of each of the entities of the group so as to generate for each original entity a duplicate,
(c) for each of said duplicates:
if the original entity has an internal link incoming from another entity of the group, modification of the corresponding link from the duplicate so as to establish it between the duplicate of said other entity toward the present duplicate,
if the original entity has an external outgoing link, abandonment of the corresponding link of the duplicate.

8. The tool according to claim 7, wherein the computer modeling software is further arranged to provide other relationships, in particular nesting, chaining and control, as well as to program any combination of the relationships available in the software.

9. The tool according to claim 8, wherein the computer modeling software is adapted to provide a text interface for editing and composing a script whereof execution is provided to order modification and display operations of the model loaded into memory.

10. A computer program product comprising code instructions for executing a method according to one of claims 1 to 6 of relational copy-paste in a tool for monitoring and controlling a complex organism development comprising components which interact with each other.

11. Storage means readable by a computer device on which a computer program product comprises code instructions for executing a method according to one of claims 1 to 6 of relational copy-paste in a tool for monitoring and controlling a complex organism development comprising components which interact with each other.
